(19) United States
(12) Patent Application Publication
(10) Pub. No.: US 2024/0125938 A1
(43) Pub. Date: Apr. 18, 2024

(54) OPTICAL SYSTEM FOR OBTAINING 3D SPATIAL INFORMATION

(71) Applicant: Scoobe3D GmbH, Augsburg (DE)

(72) Inventor: Julian Berlow, Augsburg (DE)

(21) Appl. No.: 18/549,915

(22) PCT Filed: Feb. 14, 2022
(86) PCT No.: PCT/EP2022/053494

§ 371 Date: Sep. 10, 2023

(30) Foreign Application Priority Data
Mar. 11, 2021 (DE) 1020211058880

(51) Int. Cl. G01S 17/894; G01S 7/499; G01S 17/86

(52) U.S. Cl. CPC G01S 17/894; G01S 7/499; G01S 17/86

(57) ABSTRACT

The invention relates to an optical system for obtaining 3D spatial information within a spatial region, in particular for detecting 3D information of an object, comprising:
a light receiving device (110) comprising at least one light detector, which is alignable or aligned with the spatial region;
an optical modulator unit (106) for rotating a polarisation of a light passing through the modulator unit (106); and
at least one polarisation filter (111), which is optically connected downstream of the modulator unit;
   wherein at least one band-pass filter is optically connected downstream of the polarisation filter and/or wherein the modulator unit comprises at least two optical modulators.

The invention relates to an optical system for obtaining 3D spatial information within a spatial region, in particular for detecting 3D information of an object, a corresponding image processing system as well as a corresponding optical method.

WO 2018/033446 A1 describes an optical device, preferably according to the time-of-flight principle, for obtaining 3D spatial information. By means of an optical modulator, light is influenced (or rotated) with respect to its polarisation, whereby a polarisation filter is connected downstream of the optical modulator, which only allows the light influenced (rotated) by the modulator in certain cases. Thus, in principle, a fast and precise acquisition of 3D spatial information can be made possible.

Starting from this prior art, it is the object of the invention to propose an optical system for detecting 3D spatial information within a spatial region, in particular for obtaining 3D information of an object, which enables precise detection of the 3D spatial information in a comparatively simple manner. Furthermore, it is the object of the invention to propose a corresponding image processing system as well as a corresponding optical method. In particular, a low-cost 3D imaging with a comparatively high accuracy (in particular in the millimetre or micrometre range) should be possible.

This object is solved in particular by the features of claim 1.

In particular, the object is solved by an optical system for obtaining 3D spatial information within a spatial region, in particular for detecting 3D information of an object (in particular of its outer surface), comprising: a light receiving device having at least one light detector which is alignable or aligned with the spatial region (or the object), at least one optical modulator unit for (variably) rotating a polarisation of a light passing through the modulator unit, and at least one polarisation filter which is optically connected upstream or (preferably) downstream of the modulator unit.

According to a first particularly preferred aspect of the invention, at least one colour, in particular band-pass filter is provided which is optically connected upstream or (preferably) downstream of the polarisation filter. It has turned out that by using such a colour, in particular band-pass filter the precision in obtaining the 3D information can be improved in a comparatively simple manner. In particular, such a colour, in particular band-pass filter can reduce noise and thereby increase accuracy comparatively significantly.

According to a second particularly preferred aspect of the invention, the modulator unit comprises at least two (optically connected in series) optical modulators (each configured separately to rotate a polarisation of a light passing through). In this context, comparatively inexpensive modulators (e.g. liquid crystal cells, in particular TN cells) can be used, whereby a comparatively high number of possible rotation angles for the rotation of the light beam can nevertheless be realised (e.g. by switching each individual modulator on and off) due to the plurality of modulators present. For example, with four modulators (liquid crystal cells), each of which can be switched on and off separately, 2⁴=16 different (polarisation) rotation angles can be realised. This plurality of modulators is employed particularly preferably in combination with the colour, in particular band-pass filter. By such a combination, a more possible blurring resulting from the plurality of modulators or a corresponding noise (of the concrete modulator unit) can be reduced in a simple way.

According to a third particularly preferred aspect of the invention, the system comprises at least one 3D information detection unit, in particular at least one RGB camera. With such an (additional) 3D information detection unit, in particular in the form of an RGB camera, a precise acquisition of 3D information under different conditions (or conditions of objects to be detected) can be achieved in a particularly simple manner. In this respect, advantages of the 3D information detection unit (RGB camera) complement synergistically with the advantages that result from the arrangement of optical modulator unit and polarisation filter. Alternatively or additionally, the system or the 3D information detection unit may comprise a fringe projection device and/or a laser scanning device and/or a laser triangulation device and/or a ToF (time of flight) camera for the detection of 3D information.

According to a fourth preferred aspect of the invention, at least one position detection unit (for the detection of a position or orientation of the light receiving device, for example RGB camera with respect to the spatial area to be detected the or object to be detected), in particular at least one gyroscope and/or accelerometer, is provided. By such a measure it is made possible that (for example automatically and/or by corresponding action of the operator of the system) the light detection unit is or can be guided in such an angle (for example around the object) at which a comparatively good (in particular optimised) detection of the 3D information is made possible. Particularly preferably, a control unit is provided which is configured to determine and/or output when there is a position (of the light detection unit) which is advantageous for measuring the spatial area relative to the spatial area to be measured, and/or a display is provided which indicates to the operator when there is a/the position (of the light detection unit) which is advantageous for measuring the spatial area relative to the spatial area to be measured.

The respective modulator unit comprises at least one modulator, preferably several modulators.

The (respective) modulator can preferably assume at least or exactly two states, preferably an inactive state in which the modulator does not (at least not substantially) rotate passing light and an active state in which the modulator can rotate the passing light by a certain angle (possibly depending on the polarisation direction of the incident light).

The (respective) modulator (in particular liquid crystal device) may be anti-reflective coated.

The (respective) modulator (in particular liquid crystal device) may be arranged within a lens.

The (respective) modulator unit may comprise a plurality of modulators for modulating the polarisation pixel by pixel, e.g. a microsystem comprising a liquid crystal micro array.

Preferably, at least one light generating device is provided for transmitting light into the spatial region. The light generating device may comprise at least one light emitter (e.g. one LED or several LEDs). In embodiments, the light generating device comprises at least one LED, for example white light LED. Alternatively or additionally, the light generating device may comprise at least or exactly one IR light emitter device (in particular NIR light emitter device).

Alternatively or additionally, the light generating device may comprise at least one light emitting device (in particular RGB light emitting device, for example in the form of at least three LEDs, in the colours R, G and B) which are configured to emit at least two, preferably at least or exactly three (or at least or exactly four) different colours.

Preferably, the light generating device comprises at least one diffuser. In particular, a combination of at least one LED and at least one diffuser ensures the “unpolarised world assumption” which is advantageous for processing the captured data and/or can provide for a sufficient brightness in a corresponding waveband, in particular to enable a comparatively short exposure time of a/the camera(s). In particular by this this the system can be used in a mobile (hand-held) manner.

In specific embodiments, the system may have a display, for example for displaying an app, which may be stored (saved) within the system, for example. The display can be designed as a touch screen.

According to embodiments, the modulator unit may comprise one or more, in particular at least or exactly three or at least or exactly four, preferably optically connected in series, liquid crystal device(s), preferably as TN-effect-based device(s), as modulator(s). By a TN-effect-based device is in particular to be understood a device which is based on the twisted nematic effect (TN-effect) (such as in particular a TN cell or Schadt-Halfrich cell). Such devices based on the TN-effect (liquid crystals) are comparatively inexpensive. In particular, with a plurality of such TN-effect-based devices, a plurality of polarisation angles or directions of the light can be achieved (by exploiting the respective change or rotation of the polarisation of the light passing through).

Preferably, the modulator unit has at least or exactly two or at least or exactly three or at least or exactly four modulators, in particular liquid crystal devices (TN cells), connected optically in series. These are preferably configured and arranged with respect to one another such that the respective optically downstream modulator (in particular with respect to its transmission behaviour and/or a transmitted intensity) is matched, in particular optimised, to at least one polarisation direction emerging from the upstream modulator. Particularly preferably, an input of the downstream modulator is optimised to the polarisation directions (usually) emerging from the upstream modulator (in particular with respect to a fabrication or configuration and positioning/orientation).

Preferably, the system comprises an evaluation unit, in particular comprising a (micro-) processor and/or (micro-) controller, for evaluating data detected by the light detection unit. In particular, the evaluation unit is configured to determine (in particular calculate) 3D spatial information about the 3D structure of the spatial area from the captured data, in particular to determine (in particular calculate) 3D information of an object (in particular on the surface thereof) and, if necessary, to output it.

In principle, the system (in particular the evaluation unit and/or the control unit explained below) can comprise at least one processor (CPU) and/or at least one (micro-) controller and/or at least one (electronic) memory.

In embodiments, the colour, in particular band-pass filter may comprise or be formed of a single colour, in particular band-pass filter, and/or a multiple colour filter, preferably triple colour, in particular band-pass filter, in particular for at least two colours (channels, preferably the colours (channels) red, green and blue).

A single-colour, in particular band-pass filter can be combined in particular in combination with at least one IR illumination (light unit), particularly preferably a NIR illumination (i.e. an illumination with light in the near infrared range). Alternatively or additionally, a triple colour, in particular band-pass filter can be combined with multi-colour illumination, in particular RGB illumination. With such solutions, also scattered light (in particular also from deeper areas of the material) can be recorded particularly effectively and evaluated accordingly. This can improve the accuracy in determining the 3D structures.

The (optional) light-generating device preferably emits polarised light or light with a preferred direction in the polarisation. Alternatively or additionally, the light generating device may also be configured to emit unpolarised light or light without a preferred direction in the polarisation. Additionally or alternatively to a light from a light-generating device, other light (e.g. sunlight and/or a room lighting) may also be used.

Preferably, an (electronic) control device/control unit is provided for controlling the optical modulator unit.

The system may be partially or fully implemented by a mobile terminal.

Preferably, the system is housed in a common assembly, for example defined by a housing. In this assembly also the above evaluation unit may be housed (partially or completely). Alternatively or additionally, the evaluation unit can be provided externally to the assembly and/or at least to the light detection unit (for example by a server, or other, in particular electronic, computing unit), which communicate with the other components of the system. This communication does not have to (but can) take place directly. It would also be conceivable that corresponding data are first recorded by the system, these are then stored in a memory (in particular of the system) and evaluated at a later time by the evaluation unit. The assembly and/or the housing can have a (maximum) diameter (in particular defined as the distance between two points of that pair of points which is the greatest distance apart) of at most 50 cm or at most 30 cm or at most 14 cm and/or at least 5 cm. The assembly may have a weight of at most 4.0 kg or at most 1.0 kg or at most 500 g and/or at least 40 g.

The system may have multiple polarising filters (possibly as a polarising filter unit and/or assembly). If this is the case, these may have a different orientation.

The (respective) colour, in particular band-pass filter may be provided within a camera module.

The system may be expandable with external optics (e.g. a lens).

The system may comprise at least one additional device, in particular at least one plug-on module, such as at least one camera, at least one remote trigger and/or at least one power bank.

The system (the unit) may be configured for communication with at least one further system and/or (other) external device, in particular wirelessly, preferably via WLAN and/or Bluetooth, and/or wired, e.g. via USB/USB-C.

Several (systems/units communicating with each other) can be provided simultaneously, for example at different angles and/or distances to the structure to be measured. By that possibly faster and/or larger 3D scans can be executed. The above-mentioned object is further solved in particular by an image processing system for obtaining 3D spatial information, which comprises an optical system of the above type.

The above-mentioned object is further solved by an optical process for obtaining 3D spatial information using an optical system as described above and/or below. Further optional process steps result from the above and following description, in particular from the described functional features, which can be implemented procedurally by corresponding process steps.

The above-mentioned object is further solved in particular by using an optical system of the type described above and/or below for obtaining 3D spatial information.

In embodiments, the system may according to preferably operate according to the time-of-flight principle and/or comprise at least one TOF camera (possibly in addition to at least one RGB camera).

In principle, it is assumed that the polarisation properties of the light reflected from a surface and/or scattered in layers close to the surface allow conclusions to be drawn about the conditions of the reflecting surface. Thereby it is significant that the nature of the light to form a transverse wave must be fulfilled.

The invention is based on the evaluation of polarisation information of the light back-reflected (or back-scattered) from the surface of an object. In particular, several (3D) images can be captured with the aid of the optical device, whereby in each case a different polarisation state can be highlighted. This adjustment of the filtering of the polarisation component can be done fast (in the range of microseconds, i.e. in particular 1 to 1,000 microseconds or even nanoseconds, in particular 1 to 1,000 ns), precisely, reliably and with low-maintenance. Here, a central component is to be seen in the optical modulator unit, which can enable this fast adjustment. Theoretically, a similar effect would also be achievable with the mechanical movement (rotation) of a (commercially available) polarisation filter. However, such a mechanical movement (rotation) is not comparable or sufficient in terms of speed, precision and reliability.

So one idea lies in particular therein that light impinging on a filter is (previously) rotated in its polarisation by an optical modulator unit (instead of rotating a polarisation filter). Such a rotation can, if necessary, be turned back again by a further optical modulator unit (comprising one or more modulator(s)) after filtering of the polarisation.

Overall, an optical device can be provided that enables an increase in accuracy by a fast, precise, reliable and low-maintenance filtering of the respective polarisation component. In particular, the filtering is achieved by a combination of an optical modulator (or several optical modulators) and a polarisation filter (or several polarisation filters). Furthermore, by the device according to the invention a possibility is provided to effectively influence the contrast in a camera image during an image capture or between image captures. This is particularly advantageous in image processing, because thereby the contrast can be subsequently adjusted in an optical manner (e.g. by software command through a computing unit) upon a change of the corresponding object under examination. This enables a comparatively high flexibility and a comparatively stable application.

In summary, polarisation information (e.g. grey scale images) is obtained in an advantageous manner in dependence from the filtered polarisation state. Thereby, a fast switching between the polarisation states (angles of rotation) to be filtered is achieved. This in turn enables an effective use of the polarisation information in the (industrial) application.

Further preferred embodiments are the subject of the dependent claims and/or following parts of the description.

Optionally, the polarisation manipulator comprises (between the polarisation filter and the light receiving device) at least one (further/second) optical modulator unit. This allows the polarisation to be rotated back (at least partially, at any angle) after rotation and filtering, if necessary, so that the effect of a rotation of a standard polarisation filter by 90 degrees can be approximated or (identically) reproduced, if necessary. In this way, the influence of the optical modulation units as a whole is possibly limited to the fact that a filtering is carried out after the polarisation and no (actually unnecessary and/or possibly even undesirable) permanent rotation of the polarisation is effected. This may be advantageous if the light detector has a polarisation-dependent sensitivity.

In alternative embodiments, at least one (further) camera, preferably at least one time-of-flight camera (in particular a PMD camera, preferably comprising a PMD sensor, in particular PMD chip, where PMD stands for Photonic Mixing Device), may be provided, which may optionally be part of the light detection unit. Images delivered by a time-of-flight camera already contain distance information, which is why it can also be spoken of 3D images. The use of a time-of-flight camera in the device according to the invention is advantageous in particular because 3D images can be obtained in this way with an accuracy in the micrometre range (1 micrometre to 1,000 micrometres) or even nanometre range (1 nanometre to 1,000 nanometres) (e.g. 1 nanometre-1,000 micrometres, preferably 1 nanometre-500 micrometres, still more preferably 1 nanometre-200 micrometres, still more preferably 1 nanometre-1,000 nanometres).

In one embodiment, a further polarisation and filter unit (comprising at least one modulator unit and at least one polarisation filter), which is reversed in terms of the order of the components (i.e. in particular in terms of the order of optical modulator and polarisation filter), is arranged (directly and/or at a small distance of, for example, less than 10 mm) in front of the light-generating device. Such a further (second) polarisation and filter unit may be arranged and configured such that the light first passes through the polarisation filter and then through the optical modulator unit. In particular, when optically active materials are illuminated and examined, the irradiated polarisation is changed by the optically active material. In this case, this means that in the case of irradiated (non-polarised) light, the evaluation device may not be able to obtain reliable analyses from the polarisation-dependent images of the light-receiving unit, since the change of the polarisation can be caused both by the geometric shape of the reflecting object as well as by the optically active material (and thus can possibly not be assigned unambiguously). In this case, the use of the (further) polarisation and filter unit before the light-generating unit is particularly advantageous, since the entire polarisation information can still be separated and processed here.

In an alternative embodiment, the light-generating device emits polarised light (or light with a, in particular clear, preferred direction in the polarisation). In a further, preferred embodiment, the light-generating device emits unpolarised light (or light without a, in particular clear, preferred direction in the polarisation). Especially when using unpolarised light, a fast and precise determination of the desired information can be achieved.

In one embodiment, the light generation unit comprises (at least one) laser. This is particularly advantageous in the case of longer distances, since lasers generate a strong light that can be collimated well. According to an alternative embodiment, the light-generating unit comprises at least one LED, optionally at least 10 LEDs, optionally at least 100 LEDs. Preferably, the light-generating unit (in particular the LEDs) is operated in a pulsed and/or modulated manner (particularly preferably according to the PWM principle) (wherein a corresponding pulse-generating and/or modulation device may be provided). By a pulsed operation the LEDs can draw a higher current (for a short time), which makes greater luminous intensities possible. A comparatively large number of LEDs enables a homogeneous illumination of the reflecting object, whereby also larger objects can be detected in their geometric shape. Furthermore, it is advantageous that a pulsed operation of the LED illumination or the flashing of the LEDs reduces the influence of extraneous light that does not originate from the light-generating device, thus increasing the quality of the image information.

The respective optical modulator preferably comprises or consists of a liquid crystal arrangement, in particular an electro-optically controlled liquid crystal arrangement. This has the advantage that the rotation of the polarisation can take place very quickly and reliably. Alternatively or additionally, the respective optical modulator may comprise at least (or exactly) one electro-optical and/or at least (or exactly) one magneto-optical and/or at least (or exactly) one acousto-optical device.

Optionally, the polarisation manipulator comprises (before the light entry) a quarter-wave plate. This allows circularly polarised light (rather than linearly polarised light) to be used. Alternatively or additionally, parallelising optics for parallelising incoming light beams may be arranged in front of the polarisation manipulator.

The respective optical modulator may have (in an active state) a slow axis, which is preferably designed such that it is aligned or alignable perpendicular to the light propagation direction and/or at a 45 degree angle to the pass direction of the polarisation filter. In this regard, the optical modulator (in the active state) may act like a half-wave plate. Furthermore, the at least one optical modulator (in an active state) may have a slow axis which is preferably designed to be aligned or alignable in the longitudinal direction (i.e. in particular in the direction of propagation of the light passing through it), whereby the optical modulator optionally allows a (continuous) phase shift (and thus polarisation rotation).

The optical device may comprise a control device for (time-dependent) control of the respective modulator unit or the respective optical modulator.

Overall, image acquisition can be enabled for several different polarisation states (or polarisation angles), whereby one image can be acquired per polarisation state. This is advantageous in that all polarisation information contained in the light can be recorded (if necessary, one after the other) and, possibly, individual images can be processed (separately from one another), so that effective utilisation of the information is made possible. Furthermore, in this way redundancies can be generated, if necessary, which make it possible to obtain more precise and more reliable information from an algorithm processing the images.

Further embodiments will be apparent from the dependant claims.

In the following, the invention will be described by means of execution examples which will be explained in more detail with reference to the figures. Hereby show:

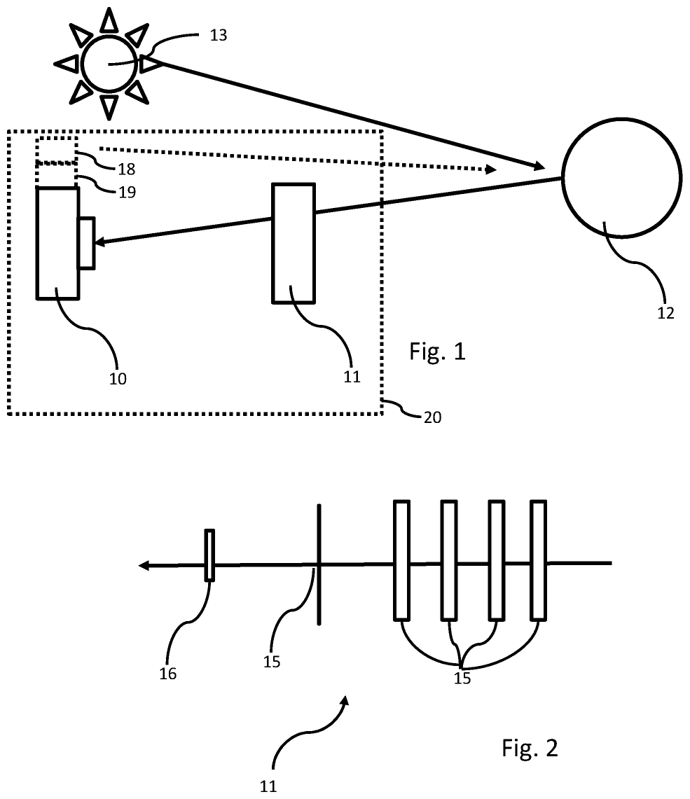

FIG. 1 a schematic view of an optical system according to the invention; and

FIG. 2 a schematic view of a section of the system according to the invention.

In the following description, the same reference numerals are used for identical parts and parts having the same effect.

FIG. 1 shows an embodiment of the optical system 9 according to the invention. This comprises an RGB camera 10 (RGB camera module) and a polarisation and filter unit 11. The system 9 is configured to determine 3D information with respect to an object 12 to be measured. In this case, the object 12 is illuminated by sunlight 13 (a light generating device would also be conceivable at reference sign 13, in particular as a component of the system).

The polarisation and filter unit 11 is shown in greater detail in FIG. 2. Accordingly, the polarisation and filter unit 11 comprises several (here specifically, which is however optional, four) modulators 14 (which may in particular be in the form of liquid crystals), a polarisation filter 15 as well as a colour filter, in particular a band-pass filter 16.

It is to be noted that polarised light basically contains 3D spatial information (cf. also WO 2018/033446 A1).

The system 9 may further comprise a gyroscope 18 and as a light generation unit 19 specifically an LED illumination with a diffuser (not shown in figures).

In the following, the mode of operation of the invention will be explained (partly on the basis of the specific execution example according to FIGS. 1 and 2).

Accordingly, the object 12 can be irradiated by the light source (for example LED with diffuser) with (at least substantially) unpolarised light. In principle, the integrated LED-based light source and/or an external light source (e.g. sun, room lighting and/or the like) can be used.

Through reflection and/or scattering, the light is now partially polarised (in interaction with the object 12). In this context, it applies to an observation of the light rays running from the object 12 to the light detection unit (specifically, RGB camera) that a strength (or an extent) of the polarisation depends on an angle of rays to the scattering or reflecting surface. Specifically, it is assumed here that not only a reflection but also a scattering polarises light rays. A polarisation is generally present in the case of scattering and/or diffuse reflection.

A first modulator 14 (rightmost in FIG. 2) can (if it is in an optically active state or is switched accordingly) rotate the polarisation of all individual photons by a certain angle. When this modulator 14 is inactive, the polarisation is not (or at least not substantially) changed.

An input of a second modulator 14 (half-right in FIG. 2) can preferably be adapted, in particular optimised, to the polarisation directions usually emerging from the rightmost modulator 14. The (in FIG. 14 half-right) second modulator can also rotate the polarisation if it is switched optically active. It applies here, again, no (or no significant) rotation takes place if the second modulator is not switched optically active.

A third (half-left in FIG. 2) and fourth (leftmost in FIG. 2) modulator are preferably configured and designed analogously to the first and second modulator, respectively.

With the configuration shown in FIG. 2, by switching on and off of the individual modulators 2⁴ (i.e. 16) different states for the polarisation (or rotation angle for the same) can be realised. 3D spatial information can then be obtained from this (as shown in greater detail in WO 2018/033446 A1).

The polarisation filter 15 can now let pass photons of a (certain) polarisation direction. Overall, the polarisation and filter unit 11 according to FIGS. 1 and 2 can provide data of a comparable quality as a rotatable polarisation filter. However, in contrast to such a rotatable polarisation filter, the solution presented here is comparatively inexpensive, requires little maintenance and has a comparatively high repeat accuracy.

Since a distance (or an extent) of the rotation of the polarisation in the respective modulator 14 can in principle be wavelength-dependent, the polarisation directions (states) can possibly be determined somewhat less precisely (or a noise can be comparatively high). By using the colour, in particular band-pass filter 16 noise can be suppressed by reducing a transmitted wavelength range and thus an accuracy can be increased (whereby the use of a triple colour, in particular band-pass filter for the colours or channels red, green and blue is employed particularly preferably here).

After passing through (if not filtered out) the polarisation and filter unit 11, the photons reach the RGB camera 10 and can be converted there into an image if necessary (or in an external evaluation unit if necessary). From (successive) intensity comparisons, spatial information can be extracted with comparatively high accuracy.

In principle, a combination of LED and diffuser (as light generating unit) ensures a simple and effective “unpolarised world assumption” and can provide a comparatively high brightness in a corresponding wavelength range, in particular to enable a short exposure time of the camera 10. In particular, this allows the system 9 to be used in a mobile (hand-held) manner.

For example, the system may be designed as a mobile terminal, in particular comprising a processor, an electronic memory and a display. A weight of the system may be less than 1 kg, possibly less than 500 g.

As explained above, polarisation can also occur in diffuse radiation and contain spatial information (even if often only polarisation by reflection is referred to in the literature). The exploitation of polarisation by scattering has not yet been described in the present context.

Instead of using a complex modulator (liquid crystal), a combination of several (simple) liquid crystal cells is particularly preferred and especially cost-effective.

The colour, in particular band-pass filter preferably reduces a noise and can increase the accuracy, for example, by at least a factor of 2 or even at least a factor of 3. The colour, in particular band-pass filter preferably has a passage width of at most 200 nm, further preferably at most 120 nm, still further preferably at most 80 nm, still further preferably at most 60 nm, still further preferably at most 40 nm and/or at least 1 nm or at least 10 nm.

Since scattering can occur in a comparatively deep region of material (compared to reflection), a respective dye of the object to be measured (or a colour thereof) can have a relevant effect on the measurement. For this reason in particular, a system with a single-colour, in particular band-pass filter as well as NIR illumination and/or a triple-colour, in particular band-pass filter and an RGB illumination is especially preferred.

At this point, it should be noted that all of the above-described parts, taken on their own and in any combination, in particular the details shown in the drawings, are claimed as essential to the invention.

Modifications hereof are familiar to the person skilled in the art.

### REFERENCE SIGNS

9 system
10 RGB camera
11 polarisation and filter unit
12 object
13 sunlight
14 modulator
15 polarisation filter
16 colour, in particular band-pass filter
18 gyroscope
19 light generating unit

1. An optical system for obtaining 3D spatial information within a spatial region, in particular for detecting 3D information of an object, comprising:
a light receiving device comprising at least one light detector, which is aligned with the spatial region;
at least one optical modulator unit for rotating a polarisation of a light passing through the at least one modulator unit; and
at least one polarisation filter, which is optically connected downstream of the at least one modulator unit;
wherein at least one colour band-pass filter, is provided, which is optically connected upstream or downstream of the polarisation filter, and/or wherein the at least one modulator unit comprises at least two optical modulators.

2. The optical system according to claim 1, further comprising:
at least one 3D information detection and/or position detection unit, in particular at least one RGB camera and/or at least one gyroscope.

3. The system according to claim 1,
including
a light generating device which has at least one light emitter for emitting light into the spatial region, wherein the light generating device comprises:
at least one LED, or
at least one diffuser or
at least one IR light emitting device or
at least one RGB light emitting device, for emitting at least two different colours.

4. The system according to claim 1, including a display.

5. The system according to claim 1, wherein the modulator unit comprises at least one liquid crystal device or TN-effect-based device connected in series.

6. The system according to claim 1,
wherein
the modulator unit comprises at least two liquid crystal devices, which are configured such that a downstream modulator is matched with at least one polarisation direction emerging from an upstream modulator.

7. The system according to claim 1,
further including
an evaluation unit comprising a processor configured for evaluating data acquired by the light detection unit.

8. The system according to claim 1,
wherein
the colour band-pass filter includes a single colour band-pass filter, a multiple colour filter, a triple colour filter, or wherein at least two colours are formed therefrom.

9. The system according to claim 1,
wherein
the light generating device emits polarised light or light with a preferred direction in polarisation, or that the light generating device emits unpolarised light or light without a preferred direction in polarisation.

10. The system according to claim 1, further including a control device for controlling the optical modulator unit.

11. The system according to claim 1, further including a housing.

12. An image processing system for obtaining 3D spatial information, comprising an optical system according to claim 1.

13. An optical method for obtaining 3D spatial information using an optical system according to claim 1.

14. Use of an optical system according to claim 1 for obtaining 3D spatial information.
